(19) United States
(12) Patent Application Publication
(10) Pub. No.: US 2009/0241497 A1
(43) Pub. Date: Oct. 1, 2009

(54) CHEMICAL FILTER AND METHOD FOR PRODUCING THE SAME

(75) Inventors: Akihiro Imai, Tokyo (JP); Takashi Tanahashi, Tokyo (JP); Toshiro Nakano, Tokyo (JP); Tainen Shimotsu, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NICHIAS Corporation, Tokyo (JP)

(21) Appl. No.: 12/353,353

(22) Filed: Jan. 14, 2009

(30) Foreign Application Priority Data
Mar. 25, 2008 (JP) 2008-078799

(51) Int. Cl. B01D 39/16; C08J 5/20; D04H 5/02

(52) U.S. Cl. 55/524; 521/25; 55/527; 55/522; 28/103; 28/107

(57) ABSTRACT

A chemical filter is obtained by pleating a nonwoven fabric, the nonwoven fabric being a spunlace nonwoven fabric prepared by causing fibers to be entangled by a spunlace method, and ion-exchange groups being introduced into the fibers by radiation graft polymerization.

### BACKGROUND OF THE INVENTION

1. Field of the Invention

The present invention relates to a chemical filter that is used to remove malodorous substances from gas or liquid, or installed in a clean room provided in a semiconductor, liquid crystal, or precision electronic component production plant or equipment used in such a clean room to remove ionic gaseous impurities, for example.

2. Description of Related Art

In forefront industries such as the semiconductor manufacturing industry and the liquid crystal manufacturing industry, it is important to control clean room air pollution and product surface pollution in order to ensure the yield, quality, and reliability of products. In the semiconductor manufacturing industry, since the degree of integration of products has increased, it has become indispensable to control ionic gaseous pollutants (basic gas and acidic gas) in addition to controlling particulate matter using an HEPA filter, a ULPA filter, or the like. For example, ammonia (i.e., basic gas) adversely affects resolution or causes the wafer surface to become clouded during exposure employed in semiconductor production. On the other hand, SO_{X} (i.e., acidic gas) causes substrate lamination defects when forming a thermal oxide film during semiconductor production, whereby the device characteristics and reliability deteriorate.

Since ionic gaseous pollutants cause various problems during semiconductor production or the like, it is desired to reduce the concentration of ionic gaseous pollutants in a clean room used in semiconductor production or the like to 1 ppb or less.

In this case, a chemical filter obtained by processing a nonwoven fabric with ion-exchange groups introduced therein is used. For example, JP-A-11-290702 (Patent Document 1) discloses a chemical filter that utilizes a nonwoven fabric formed of a polyolefin fiber produced by a melt blow method (i.e., spunbond method) and having an average fiber diameter of 10 μm or less, the chemical filter being provided with ion-exchange capability by UV graft polymerization, a chemical filter that utilizes a nonwoven fabric prepared by a hydro-entanglement method in which a web is formed by a polyolefin fiber produced by a melt blow method and having an average fiber diameter of 10 μm or less, the chemical filter being provided with ion-exchange capability by UV graft polymerization, and a chemical filter that utilizes a nonwoven fabric prepared by integrally laminating at least two of a web formed by a polyolefin fiber prepared by a melt blow method and having an average fiber diameter of 10 μm or less, a web prepared by a spunbond method and having an average fiber diameter of 50 μm or less, and a short fiber web by thermocompression bonding, the chemical filter being provided with ion-exchange capability by UV graft polymerization.

JP-A-8-199480 (Patent Document 2) discloses a gas adsorbing material obtained by subjecting a nonwoven fabric obtained by a thermal bond method using a fiber with a core-sheath structure to radiation grafting to introduce ion-exchange groups into the nonwoven fabric.

A chemical filter installed in a clean room or the like is required to maintain a high capability of removing ionic gaseous pollutants for a long period of time (i.e., long life).

However, the chemical filters disclosed in Patent Documents 1 and 2 have a limited life.

### SUMMARY OF THE INVENTION

Accordingly, an object of the present invention is to provide a chemical filter which maintains capability of removing ionic gaseous pollutants for a long period of time.

The inventors of the present invention conducted extensive studies in order to solve the above-mentioned problems. As a result, the inventors found that a chemical filter obtained by pleating a nonwoven fabric exhibits the following properties (1) and (2). Specifically, (1) when a spunlace nonwoven fabric prepared by causing fibers to be entangled by a spunlace method is used as the nonwoven fabric and ion-exchange groups are introduced into the fibers by radiation graft polymerization, a chemical filter in which ion-exchange groups are uniformly dispersed can be obtained (i.e., a chemical filter having a long life can be obtained), and (2) when a spunlace nonwoven fabric prepared from one or more fibers selected from a rayon fiber, a pulp fiber, a cotton fiber, and a cotton-linter fiber is used as the nonwoven fabric and ion-exchange groups are introduced by radiation graft polymerization in an amount of 5.0 meq/g or more (cation-exchange groups) or 4.0 meq/g or more (anion-exchange groups), a chemical filter in which a large number of ion-exchange groups are uniformly dispersed can be obtained (i.e., a chemical filter having a long life can be obtained). These findings have led to the completion of the present invention.

Specifically, a first aspect of the present invention provides a chemical filter obtained by pleating a nonwoven fabric, the nonwoven fabric being a spunlace nonwoven fabric prepared by causing fibers to be entangled by a spunlace method, and ion-exchange groups being introduced into the fibers by radiation graft polymerization.

A second aspect of the present invention provides a method for producing a chemical filter comprising preparing a spunlace nonwoven fabric by causing organic fibers to be entangled by a spunlace method, introducing ion-exchange groups into the fibers of the spunlace nonwoven fabric by radiation graft polymerization, and pleating the resulting nonwoven fabric.

A third aspect of the present invention provides a method for producing a chemical filter comprising introducing ion-exchange groups into organic fibers by radiation graft polymerization causing the fibers to be entangled by a spunlace method to prepare a spunlace nonwoven fabric, and pleating the resulting nonwoven fabric.

According to the present invention, a chemical filter which can remove ionic gaseous pollutants for a long period of time can be provided.

### BRIEF DESCRIPTION OF THE DRAWING

FIG. 1 is a schematic perspective view showing an example of a chemical filter according to the present invention.

### DETAILED DESCRIPTION OF THE INVENTION AND PREFERRED EMBODIMENTS

The chemical filter according to the present invention is obtained by pleating a nonwoven fabric. The nonwoven fabric is a spunlace nonwoven fabric prepared by causing fibers to be entangled by a spunlace method, and ion-exchange groups are introduced into the fibers by radiation graft polymerization.

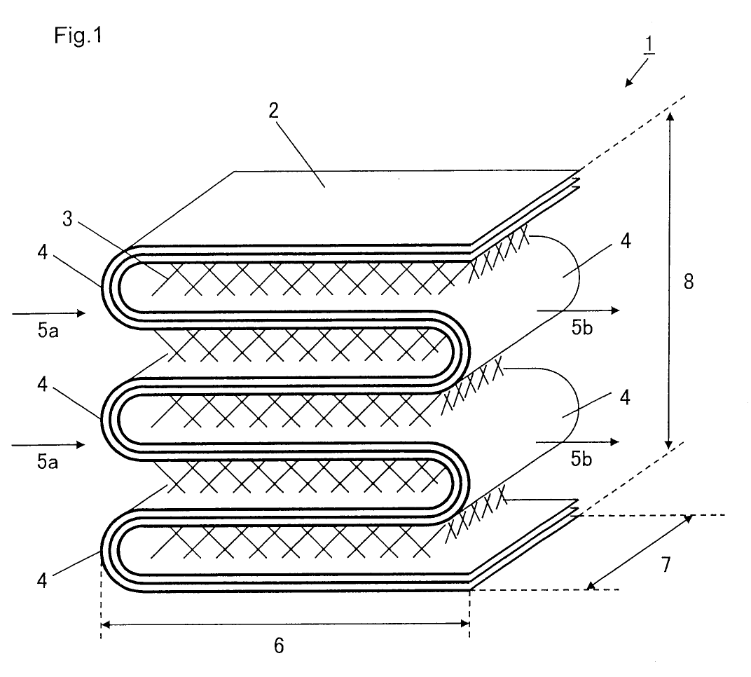

The chemical filter according to the present invention is obtained by pleating the nonwoven fabric. The chemical filter according to the present invention will be described with reference to FIG. 1. FIG. 1 is a schematic perspective view showing an example of the chemical filter according to the present invention. In FIG. 1, a chemical filter 1 has a pleated form made by laminating three sheets of nonwoven fabric 2, and folding the laminate to form creases 4. A spacer 3 is normally provided in order to prevent direct contact between the nonwoven fabrics 2. Air to be processed is caused to flow through the chemical filter 1 in the direction vertical to the creases 4 of the nonwoven fabric 2 (direction indicated by arrows 5a and 5b).

The nonwoven fabric used in the chemical filter according to the present invention is a spunlace nonwoven fabric prepared by a spunlace method in which fibers are caused to be entangled using a high-pressure water stream.

The fiber that forms the nonwoven fabric of the chemical filter according to the present invention is an organic fiber. Examples of the organic fiber include a rayon fiber, a pulp fiber, a cotton fiber, a cotton-linter fiber, a nylon fiber, a polyester fiber, a polyethylene fiber, a polypropylene fiber, an aramid fiber, and the like. It is preferable to use a rayon fiber, a pulp fiber, a cotton fiber, or a cotton-linter fiber, either alone or in combination, (rayon fiber is particularly preferable) since a large number of ion-exchange groups can be introduced. This leads to high removal performance when removing ionic gaseous pollutants, and hence a long life. A large number of ion-exchange groups can be introduced into a rayon fiber, pulp fiber, cotton fiber, or cotton-linter fiber (particularly rayon fiber) by radiation graft polymerization since the impregnation rate with the monomer solution can be increased. The fiber diameter of the organic fibers is preferably 5 to 20 μm.

When producing the nonwoven fabric used i the chemical filter according to the present invention, a spunlace nonwoven fabric is produced by causing the fibers to be entangled by applying a high-pressure water stream (spunlace method). In the spunlace method, high-pressure water is discharged to a web from a nozzle or the like so that the fibers are entangled due to the water stream. When producing the chemical filter according to the present invention, the spunlace conditions (e.g., water pressure and the number of treatments) may be appropriately selected.

Ion-exchange groups are introduced into the fibers that form the nonwoven fabric by radiation graft polymerization. Specifically, the nonwoven fabric is a nonwoven fabric into which ion-exchange groups are introduced.

The ion-exchange group introduced into the fibers that form the nonwoven fabric may be a cation-exchange group or an anion-exchange group. Examples of the cation-exchange group include a sulfonic acid group, a carboxyl group, a phosphoric acid group, a phosphonic acid group, a sulfoethyl group, a phosphomethyl group, a carbomethyl group, and the like. These groups may be used either alone or in combination. Examples of the anion-exchange group include a quaternary ammonium group, a primary amino group, a secondary amino group, a tertiary amino, group, a methylamino (group, and the like. These golups may be used either alone or in combination.

A nonwoven fabric into which ion-exchange groups are introduced may be obtained by the following methods, for example. (1) A spunlace nonwoven fabric is prepared by causing organic fibers (preferably rayon fibers, pulp fibers, cotton fibers, or cotton-linter fibers) to be entangled by a spunlace method, and ion-exchange groups are introduced into the fibers by subjecting polymerizable monomer to radiation graft polymerization. (2) Ion-exchange groups are introduced into organic fibers (preferably rayon fibers, pulp fibers, cotton fibers, or cotton-linter fibers) by subjecting polymerizable monomers to radiation graft polymerization, and the resulting fibers are entangled by a spunlace method.

Radiation graft polymerization may be carried out as follows, for example. (i) A method of irradiating a material to be polymerized and coating or impregnating the irradiated material to be polymerized with the monomer solution to graft-polymerize the polymerizable monomer by radiation and (ii) a method of first coating or impregnating a material to be polymerized with the monomer solution and applying radiation to the material which is coated or impregnated with the monomer solution to graft polymerize the polymerizable monomer can be given. In the radiation graft polymerization in the above (i) or (ii), the atmosphere is replaced with an inert gas such as nitrogen gas prior to irradiation to carry out the graft polymerization in an inert gas atmosphere. The “material to be polymerized” in the present invention refers to an object to be graft polymerized by radiation into which the polymer chains of the polymerizable monomer are to be introduced. The radiation graft polymerization of the above method (ii) is preferred due to low production cost, since only the part coated or impregnated with the monomer solution of the material to be polymerized is required to be kept in an inert gas atmosphere.

The polymerizable monomer used for radiation graft polymerization includes a polymerizable monomer having a cation-exchange group, a polymerizable monomer having a salt group of the cation-exchange group, a polymerizable monomer having an anion-exchange group, a polymerizable monomer having a salt group of the anion-exchange group, or a polymerizable monomer having a substituent of which the functional group is convertible into an ion-exchange group by an appropriate method.

When the ion-exchange group introduced into the nonwoven fabric is a cation-exchange group, sodium styrenesulfonate, sodium 2-acrylamide-2-methylpropane sulfonate, acrylic acid, methacrylic acid, and sodium allylsulfonate can be given as examples of the polymerizable monomers used for the graft polymerization. These polymerizable monomers may be used either individually or in combination. In the case of the polymerizable monomer having a salt group of the cation-exchange group, the salt group of the cation-exchange group may be converted into the cation-exchange group by an acid treatment after radiation graft polymerization. The salt group of the cation-exchange group refers to a neutralized cation-exchange group such as a sodium sulfonate group (—SO₃Na) of sodium styrene sulfonate, for example.

For example, when the organic fiber has a hydroxyl group such as a rayon fiber, a pulp fiber, a cotton fiber, or a cotton-linter fiber, the sulfonate salt group (chemical formula: —SO₃Na) may be introduced into such a fiber by coating or impregnating the material to be polymerized (which is made of the fiber) with an aqueous solution of sodium sulfite or sodium hydrogensulfite, followed by irradiation. The compound such as sodium sulfite or sodium hydrogensulfite which is capable of introducing an ion-exchange group into a fiber by radiation is also included in the polymerizable monomer.

When the ion-exchange group introduced into the nonwoven fabric is an anion-exchange group, vinylbenzyltrimnethyl ammonium salt, diethylaminoethyl methacrylate, dimethylaminoethyl acrylate, and dimethylaminoethyl methacrylate can be (liven as examples of the polymerizable monomers used for the graft polymerization. These polymerizable monomers may be used either individually or in combination. In the case of the polymerizable monomer having a salt group of the anion-exchange group, the salt group of the anion-exchange group may be converted into the anion-exchange group by an alkali treatment after radiation graft polymerization.

As examples of the radiation used in radiation graft polymerization, ultraviolet rays, electron beams, X-rays, α-rays, β-rays, and γ-rays can be given. Of these, electron beams and γ-rays are preferable. The dose of radiation used in the radiation graft polymerization may be appropriately selected according to the degree of graft polymerization. Usually, 30 to 200 kGy is preferable when electron beams are used, and 100 to 800 kGy is preferable when γ-rays are used.

As examples of the solvent for the polymerizable monomer used in the radiation graft polymerization, hydrophilic solvents such as water and alcohol can be given. The concentration of the polymerizable monomer in the monomer solution may be appropriately selected, preferably from the range of 40 to 70 mass %.

The ion-exchange capacity of the nonwoven fabric having ion-exchange groups introduced therein is 5.0 meq/g or more, preferably 5.5 to 6.0 meq/g in the case of the cation-exchange group, and 4.0 meq/g or more, preferably 4.5 to 5.0 meq/g in the case of the anion-exchange group. If the ion-exchange capacity of the nonwoven fabric is in the above range, the chemical filter possesses a large absorption capacity and has a long life.

The basis weight of the nonwoven fabric into which ion-exchange groups are introduced is preferably 50 to 200 g/m², and particularly preferably 100 to 160 g/m². The thickness of the nonwoven fabric having an ion-exchange group introduced therein is preferably 0.3 to 1.5 mm, and particularly preferably 0.6 to 1.0 mm.

There are no specific limitations to the shape, the size, the folding pitch, and the like of the nonwoven fabric with an ion-exchange group introduced therein in the chemical filter according to the present invention, insofar as the nonwoven fabric is pleated. The chemical filter shown in FIG. 1 is an embodiment obtainable by laminating three sheets of nonwoven fabric and pleating the laminate. The number of sheets in the chemical filter according to the present invention is not particularly limited but may usually be 1 to 4, and preferably 2 to 3.

The chemical filter according to the present invention is suitably installed in a clean room or in equipment used in a clean room of a plant for manufacturing semiconductors, liquid crystal displays, and precision electronic components.

When the method (1) of first preparing a spunlace nonwoven fabric by causing an organic fiber, preferably a rayon fiber, a pulp fiber, a cotton fiber, or a cotton-linter fiber, to be entangled by a spunlace method and introducing an ion-exchange group into the fibers which form the spunlace nonwoven fabric by radiation graft polymerization is used for obtaining the nonwoven fabric having an ion-exchange group introduced therein in the chemical filter according to the present invention, the water absorption rate of the spunlace nonwoven fabric before introducing the ion-exchange group is preferably 50 to 300 mass %, and particularly preferably 150 to 200 mass %. The water absorption rate of the spunlace nonwoven fabric before introducing the ion-exchange group in the above range enables a large number of ion-exchange groups to be introduced into the nonwoven fabric, resulting in a chemical filter having high performance in eliminating ionic gaseous pollutants and also a long life.

The water absorption rate can be determined by the following method. First, the nonwoven fabric is dipped in water by placing the fabric almost parallel to the water surface to cause the nonwoven fabric to absorb water. Then, the nonwoven fabric which has absorbed water is removed from the water by drawing from the water while maintaining an almost parallel state to the water surface. The nonwoven fabric is then held above the water until no more water drips therefrom. The water absorption rate is calculated using the following formula (1).

Water absorption rate (%)={(B−A)/A}×100 (1)

where, A is the mass (g) of the nonwoven fabric before absorbing water, and B is the mass (g) of the nonwoven fabric when no more water drips therefrom.

When the above method (1) (ii) of first coating or impregnating the spunlace nonwoven fabric (material to be polymerized) with the monomer solution and applying radiation to the material to graft polymerize the polymerizable monomer is used for obtaining the nonwoven fabric having the ion-exchange group introduced therein in the chemical filter according to the present invention, the amount of the monomer solution to be coated or impregnated (impregnation rate) is preferably 50 to 300 mass %, and particularly preferably 150 to 200 mass % of the spunlace nonwoven fabric. The impregnation rate in the above range enables a large number of ion-exchange groups to be introduced into the nonwoven fabric, resulting in a chemical filter having high performance in eliminating ionic gaseous pollutants and also a long life. The impregnation rate of the monomer solution in the spunlace nonwoven fabric of the present invention can be determined by the following formula (2),

Impregnation rate of spunlace nonwoven fabric with monomer solution (%)={(D−C)/C}×100 (2)

wherein C is the mass (g) of the spunlace nonwoven fabric before being coated or impregnated with the monomer solution and D is the mass (g) of the spunlace nonwoven fabric after having been coated or impregnated with the monomer solution.

When the spunlace nonwoven fabric is coated or impregnated with the monomer solution in an amount exceeding the amount which can be absorbed by the spunlace nonwoven fabric, water drips from the spunlace nonwoven fabric which is held almost horizontally. The mass of the spunlace nonwoven fabric when no more water drips therefrom is regarded as the mass D (g) of the spunlace nonwoven fabric after having been coated or impregnated with the monomer solution.

The method for producing a chemical filter of the first embodiment in the present invention comprises preparing a spunlace nonwoven fabric by causing an organic fiber, preferably one or more fibers selected from a rayon fiber, a pulp fiber, a cotton fiber, and a cotton-linter fiber, to be entangled by a spunlace method, introducing ion-exchange groups into the resulting spunlace nonwoven fabric by radiation graft polymerization, and processing the resulting nonwoven fabric into which the ion-exchange groups have been introduced by pleating.

The method for producing a chemical filter of the second embodiment in the present invention comprises introducing ion-exchange groups into an organic fiber, preferably one or more fibers selected from a rayon fiber, a pulp fiber, a cotton fiber, and a cotton-linter fiber, by radiation graft polymerization, causing the resulting fiber to be entangled by a spunlace method to obtain a spunlace nonwoven fabric, and processing the resulting nonwoven fabric into which the ion-exchange groups have been introduced by pleating.

The same method of obtaining a nonwoven fabric having an ion-exchange group introduced therein as described for the chemical filter according to the present invention may be applied to the production of a nonwoven fabric having an ion-exchange group introduced therein in the method for producing a chemical filter of the first embodiment and the method for producing a chemical filter of the second embodiment. The same spunlace method and radiation graft polymerization as described for the chemical filter according to the present invention may be applied to the spunlace method and the radiation graft polymerization in the method for producing a chemical filter of the first embodiment and the method for producing a chemical filter of the second embodiment.

Since the chemical filter according to the present invention employs a spunlace nonwoven fabric prepared by a spunlace method, the fiber is uniformly distributed. In addition, the nonwoven fabric contains ion-exchange groups introduced therein by radiation graft polymerization. Since the nonwoven fabric which forms the chemical filter contains ion-exchange groups uniformly distributed therein, the chemical filter according to the present invention has high performance in eliminating ionic gaseous pollutants and a long life.

A large number of ion-exchange groups can be uniformly introduced into the nonwoven fabric of the chemical filter according to the present invention by using a rayon fiber, a pulp fiber, a cotton fiber, or a cotton-linter fiber as the material to be polymerized and utilizing radiation graft polymerization as the method of introducing ion-exchange groups. For this reason, the chemical filter according to the present invention exhibits high elimination performance and has a long life.

The present invention will be described in more detail by examples, which should not be construed as limiting the present invention.

### EXAMPLES

### Example 1

### (Preparation of Nonwoven Fabric in Which Ion-Exchange Groups are Introduced)

A spunlace rayon nonwoven fabric with a basis weight of 160 g/m², a thickness of 0.9 mm, and a fiber diameter of about 20 μm was prepared by a spunlace method. A monomer aqueous solution containing 20 mass % of sodium styrene sulfonate and 40 mass % of acrylic acid was applied to the resulting spunlace rayon nonwoven fabric in an amount of 300 g/m². The impregnation rate of the spunlace rayon nonwoven fabric with the monomer solution was 187.5%.

The nonwoven fabric provided with the monomer aqueous solution was irradiated with γ-rays in a nitrogen atmosphere. The dose was 400 kGy.

After irradiation, the nonwoven fabric was caused to come in contact with a sulfuric acid aqueous solution to replace sodium in the nonwoven fabric by a proton (H⁺) to obtain a nonwoven fabric into which ion-exchange groups were introduced.

The ion-exchange capacity of the resulting nonwoven fabric was 5.8 meq/g.

### (Production of Chemical Filter)

The nonwoven fabric thus obtained was pleated as follows to obtain a chemical filter.

### <Specification>

Dimensions of chemical filter: thickness: 150 mm, width: 130 mm, height: 130 mm (thickness: 6 in FIG. 1, width: 7 in FIG. 1, height: 8 in FIG. 1)
Folding pitch: 79 creases/m

### (Life Test of Chemical Filter)

A life test was conducted on the chemical filter thus obtained under the following conditions using ammonia (i.e., removal target gas). The period of time elapsed up to the time when the removal rate decreased to 90% was regarded as the life of the chemical filter. The life of the chemical filter thus determined was 400 hours.

The ammonia concentration causing problems in a clean room or the like is in the order of ppb by volume. In the examples, an ammonia concentration of 2000 ppb by volume was used (accelerated test).

### <Test Conditions>

Target gas: ammonia (2000 ppb by volume)
Flow rate: 0.5 m/sec

### Comparative Example 1

### (Preparation of Nonwoven Fabric Into Which Ion-Exchange Groups are Introduced)

A thermal-bonded nonwoven fabric with a basis weight of 160 g/m², a thickness of 0.9 mm, and a fiber diameter of about 20 μm was prepared by a thermal bond method using fibers with a core-sheath structure (core: polyethylene terephthalate, sheath: polyethylene).

A monomer aqueous solution containing 20 mass % of sodium styrene sulfonate and 40 mass % of acrylic acid was applied to the resulting thermal-bonded nonwoven fabric. Notwithstanding the attempt of applying 300 g/m², only 180 g/m² was applied to the nonwoven fabric due to dripping of the solution. The impregnation rate of the thermal-bonded nonwoven fabric with the monomer solution was 112.5%.

The thermal-bonded nonwoven fabric to which the monomers were applied was irradiated with γ-rays in a nitrogen atmosphere. The dose was 400 kGy.

After irradiation, the nonwoven fabric was caused to come in contact with a sulfuric acid aqueous solution to replace sodium in the nonwoven fabric by a proton (H⁺) to obtain a nonwoven fabric into which ion-exchange groups were introduced.

The ion-exchange capacity of the nonwoven fabric thus obtained was 4.4 meq/g.

### (Production of Chemical Filter)

The resulting nonwoven fabric was processed in the same manner as in Example 1 to obtain a chemical filter.

### (Life Test of Chemical Filter)

The life test of the chemical filter was carried out in the same manner as in Example 1. The life of the chemical filter was 240 hours.

According to the present invention, a chemical filter having a high ionic gaseous pollutant removal performance and a long life can be obtained.

Obviously, numerous modifications and variations of the present invention are possible in the light of the above teachings. It is therefore to be understood that, within the scope of the appended claims, the invention may be practiced otherwise than as specifically described herein.

What is claimed is:

1. A chemical filter obtained by pleating a nonwoven fabric, the nonwoven fabric being a spunlace nonwoven fabric prepared by causing fibers to be entangled by a spunlace method, and ion-exchange groups being introduced into the fibers by radiation graft polymerization.

2. The chemical filter according to claim 1, wherein the fibers forming the spunlace nonwoven fabric are one or more fibers selected from a rayon fiber, a pulp fiber, a cotton fiber, and a cotton-linter fiber.

3. The chemical filter according to claim 1 or 2, wherein the ion-exchange capacity of the nonwoven fabric is 5.0 meq/g or more in the case of cation-exchange groups and 4.0 meq/g or more in the case of anion-exchange groups.

4. The chemical filter according to any one of claims 1 to 3, wherein the spunlace nonwoven fabric is impregnated with a monomer solution in an amount of 50 to 300 mass % before the ion-exchange groups are introduced by radiation graft polymerization.

5. The chemical filter according to any one of claims 1 to 4, wherein the radiation graft polymerization comprises first coating or impregnating a material to be polymerized with the monomer solution, and applying radiation to the material.

6. A method for producing a chemical filter comprising preparing a spunlace nonwoven fabric by causing organic fibers to be entangled by a spunlace method, introducing ion-exchange groups into the fibers of the spunlace nonwoven fabric by radiation graft polymerization, and pleating the resulting nonwoven fabric.

7. A method for producing a chemical filter comprising introducing an ion-exchange group into organic fibers by radiation graft polymerization, causing the resulting fibers to be entangled by a spunlace method to prepare a spunlace nonwoven fabric, and pleating the resulting nonwoven fabric.

8. The method for producing a chemical filter according to claim 6 or 7, wherein the organic fibers are one or more fibers selected from a rayon fiber, a pulp fiber, a cotton fiber, and a cotton-linter fiber.

9. The chemical filter according to claim 6, wherein the spunlace nonwoven fabric is impregnated with a monomer solution in an amount of 50 to 300 mass % before the ion-exchange groups are introduced by radiation graft polymerization.
